(19) United States
(12) Patent Application Publication
(10) Pub. No.: US 2026/0097665 A1
(43) Pub. Date: Apr. 9, 2026

(54) METHOD FOR CONTROLLING DUAL BATTERIES AND VEHICLE USING THE SAME

(71) Applicants: HYUNDAI MOTOR COMPANY, Seoul (KR); KIA CORPORATION, Seoul (KR)

(72) Inventor: Won Jae Lee, Hwaseong-si (KR)

(73) Assignees: HYUNDAI MOTOR COMPANY, Seoul (KR); KIA CORPORATION, Seoul (KR)

(21) Appl. No.: 19/263,474

(22) Filed: Jul. 8, 2025

(30) Foreign Application Priority Data
Oct. 8, 2024 (KR) 10-2024-0137007

(51) Int. Cl. B60L 50/60; B60L 58/12; B60L 58/22; B60L 58/26

(52) U.S. Cl. CPC B60L 50/60; B60L 58/12; B60L 58/22; B60L 58/26; B60L 2210/42; B60L 2240/64; B60L 2240/662

(57) ABSTRACT

A method for controlling dual batteries to supply power to a driving motor for wheel driving installed in a vehicle is provided. The method includes controlling a power flow between a first battery and a second battery. Controlling the power flow includes determining a usage plan of the first battery and the second battery for each section of an expected driving path, and charging or discharging the first battery and the second battery based on the usage plan.

### CROSS-REFERENCE TO RELATED APPLICATION(S)

The present application claims priority to Korean Patent Application No. 10-2024-0137007, filed on Oct. 8, 2024, the entire contents of which are incorporated herein for all purposes by this reference.

### TECHNICAL FIELD

The present disclosure relates to a method for controlling dual batteries and a vehicle using the same.

### BACKGROUND

In general, an electric vehicle is a kind of mobility device that runs as the wheels are driven by a driving force of a driving motor.

Also, in general, a high-voltage battery may be fixedly mounted onto a vehicle to supply power to the driving motor.

The driving motor may be an AC motor, and accordingly, an inverter may be provided between the battery and the driving motor.

The battery of the electric vehicle is charged by receiving external power through an on board charger (OBC) when charging is needed (e.g., required) according to a charge state thereof, e.g., state of charge (SoC).

A charging time may be determined according to a charging method and divided into slow charging and fast charging.

In recent years, continuing researches and developments on batteries have improved a driving range per charge.

However, the battery mounted on the electric vehicle may still be insufficient, and therefore, an alternative may be useful.

### SUMMARY

The present disclosure may relieve or solve at least one of the above-described limitations.

The present disclosure provides a concept of using a second (e.g., high-voltage battery) that may be added to and detached from a power system of an electric vehicle as desired (or as necessary) in addition to a first high-voltage battery installed (e.g., in advance) in the electric vehicle.

The present disclosure also provides a method for determining a usage plan of dual batteries for each section of an expected driving path to obtain an efficient operation of the dual batteries.

The present disclosure also provides a method for reducing a loss in a power circuit and improving a battery conditioning efficiency by executing a battery operation corrected based on a usage plan when replacing dual batteries according to the usage plan.

An example embodiment of the present disclosure provides a method for controlling dual batteries to supply power to a driving motor for wheel driving installed in a vehicle and control a power flow between a first battery of the dual batteries and a second battery of the dual batteries. The method includes determining, by a controller, a usage plan of the first battery and the second battery for a section of an expected driving path, and performing a charging or discharging process for the first battery and the second battery based on the usage plan.

In an example embodiment, the method may further include correcting a first usage plan for a first section in which both the first battery and the second battery are to be used according to the determined usage plan.

In an example embodiment, correcting the first usage plan may include correcting the first usage plan based on an expected consumption energy of both the first battery and the second battery.

In an example embodiment, the expected consumption energy may include at least one of a battery discharging energy, a battery charging energy, a battery conditioning energy, or a coolant energy.

In an example embodiment, correcting the first usage plan may include comparing first expected consumption energy for the first battery with second expected consumption energy for the second battery.

In an example embodiment, correcting the first usage plan may include determining the second battery as a battery for the charging or discharging process in the first section when the first expected consumption energy is greater than the second expected consumption energy, or determining the first battery as a battery for the charging or discharging process in the first section when the first expected consumption energy is less than the second expected consumption energy.

In an example embodiment, correcting the first usage plan may further include maintaining the first usage plan when a sum of conditioning energy and coolant energy related to the first battery or the second battery for the first section is less than a set energy.

In an example embodiment, the first section may include a section in which the first battery is to be used for one of a charging process and a discharging process, and the second battery is to be used for the other.

In an example embodiment, the method may further include dividing the expected driving path into sections based on driving conditions to determine at least one section, and determining expected power for each of the at least one section based on driving habit data, in which the determining the usage plan may include determining the usage plan based on the expected power.

In an example embodiment, the method may further include performing a conditioning control for the first battery or the second battery based on the usage plan.

In an example embodiment of the present disclosure, a vehicle includes a plurality of wheels, a driving motor configured to drive at least one of the plurality of wheels, and a controller configured to control a power flow between the driving motor and a first battery or a second battery. The controller comprises a memory storing computer-readable instructions and at least one processor configured to execute the computer-readable instructions. The computer-readable instructions are configured to cause the controller, when executed by the at least one processor, to determine a usage plan of the first battery and the second battery for section of an expected driving path, and perform a charging or discharging process for the first battery and the second battery based on the usage plan.

In an example embodiment, the computer-readable instructions may be further configured to cause the controller to correct a first usage plan for a first section in which both the first battery and the second battery are to be used according to the determined usage plan.

In an example embodiment, the computer-readable instructions may be further configured to cause the controller to correct the first usage plan based on expected consumption energy caused by use of both the first battery and the second battery.

In an example embodiment, the expected consumption energy may include at least one of a battery discharging energy, a battery charging energy, a battery conditioning energy, or a coolant energy.

In an example embodiment, the computer-readable instructions may be further configured to cause the controller to compare a first expected consumption energy for the first battery with a second expected consumption energy for the second battery.

In an example embodiment, the computer-readable instructions may be further configured to cause the controller to determine the second battery as a battery for the charging or discharging process in the first section when the first expected consumption energy is greater than the second expected consumption energy, or determining the first battery as a battery for the charging or discharging process in the first section when the first expected consumption energy is less than the second expected consumption energy.

In an example embodiment, the computer-readable instructions may be further configured to cause the controller to maintain the first usage plan when a sum of conditioning energy and coolant energy related to the first battery or the second battery for the first section is less than a set energy.

In an example embodiment, the first section may comprise a section in which the first battery is to be used for one of a charging process and a discharging process, and the second battery is to be used for the other.

In an example embodiment, the computer-readable instructions may be further configured to cause the controller to divide the expected driving path into sections based on driving conditions to determine at least one section and determines expected power for each of the at least one section based on driving habit data, wherein the determining of the usage plan comprises determining the usage plan based on the expected power.

In an example embodiment, the computer-readable instructions may be further configured to cause the controller to perform a conditioning control for the first battery or the second battery based on the usage plan.

### BRIEF DESCRIPTION OF THE DRAWINGS

FIG. 1 is a view illustrating a power system of a first mobility according to an example embodiment of the present disclosure.

FIG. 2 is a view illustrating a state in which the first mobility is connected to a second mobility according to an example embodiment of the present disclosure.

FIG. 3 is a flowchart illustrating a process of controlling dual batteries according to an example embodiment of the present disclosure.

FIG. 4 is a flowchart illustrating a process of checking and adjusting a battery usage plan according to an example embodiment of the present disclosure.

FIG. 5 is a table illustrating an example of driving habit data for each driving condition.

FIGS. 6A and 6B are graphs illustrating a driving simulation according to an example embodiment of the present disclosure.

FIG. 7 is a graph illustrating another driving simulation according to an example embodiment of the present disclosure.

FIG. 8 is a graph illustrating an example embodiment of a battery usage plan for each section and a final determination in FIG. 7.

### DETAILED DESCRIPTION

Since the present disclosure may have diverse modified embodiments, example embodiments are illustrated in the drawings and are described in the detailed description of the disclosure. However, this does not limit the present disclosure within the example embodiments and it should be understood that the present disclosure covers the modifications, equivalents, and replacements within the idea and technical scope of the present disclosure.

In this specification, the suffixes “module” and “unit” are used for nominal distinction between components and should not be interpreted as implying that the components are physically or chemically separated or that they may be separated.

Although the terms of “first” and “second” are used herein to describe various elements, these elements should not be limited by these terms. These terms may be used to differentiate one component from another in name, and their sequential meanings are understood through the context of the description rather than by the names themselves.

The term “and/or” is used to include possible combinations of the listed items. For example, “A and/or B” includes three cases of “A”, “B”, and “A and B”.

When an element is referred to as being “connected to” or “engaged with” another element, it may be directly connected to the other element, or intervening elements may also be present.

In the following description, the technical terms may be used for explaining a specific exemplary embodiment while not limiting the present disclosure. The terms of a singular form may include plural forms unless referred to the contrary. The meaning of ‘include’ or ‘comprise’ specifies a property, a region, a set (e.g., fixed) number, a step, a process, an element and/or a component but does not exclude other properties, regions, set (e.g., fixed) numbers, steps, processes, elements and/or components.

Unless terms used in the present disclosure are provided differently, the terms may be construed as understood by those skilled in the art. Terms such as terms that are generally in dictionaries should be construed as having meanings matched with contextual meanings in the art. In this description, unless provided, terms should not be construed to have ideally, excessively construed as formal meanings.

Also, the terms unit, control unit, control device, or controller are used to name devices that control specific functions and do not refer to a generic functional unit. Also, the devices denoted by the names may include a communication device that communicates with another controller or sensor to control the corresponding function, a computer-readable recording medium that stores an operation system, a logic command, and input/output information, and at least one processor that performs determinations, decisions, and calculations required for function control.

The processor may include semiconductor integrated circuits and/or electronic elements that perform at least one or more comparisons, determinations, calculations, and/or decisions to achieve programmed functions. For example, the processor may be a computer, a microprocessor, CPU, ASIC, an electronic circuitry (logic circuits), or a combination thereof.

Also, the computer readable recording medium (or memory) includes various data storage devices that store computer readable data. For example, the computer readable recording medium may include at least one of a flash memory type, hard disk type, micro type, card type (e.g., secure digital (SD) card) or eXtream digital (XD) type memory and a random access memory (RAM), static RAM (SRAM), read-only memory (ROM), programmable ROM (PROM), electrically erasable PROM (EEPROM), magnetic RAM (MRAM), magnetic disk, or optical disk type memory.

The recording media may be electrically connected to the processor, and the processor may read data from and write data to the recording media. The recording media and the processor may be integrated with each other or physically separated from each other.

Hereinafter, the accompanying drawings provide at least one embodiment of the present disclosure and will be described in detail with reference to the drawings.

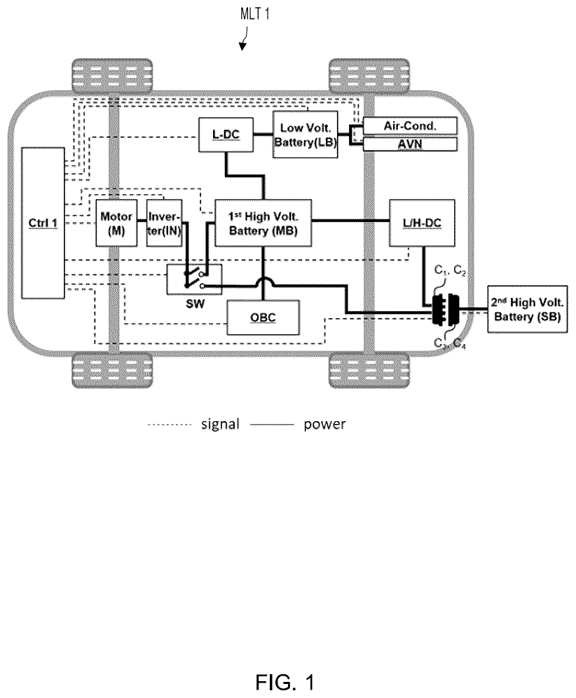

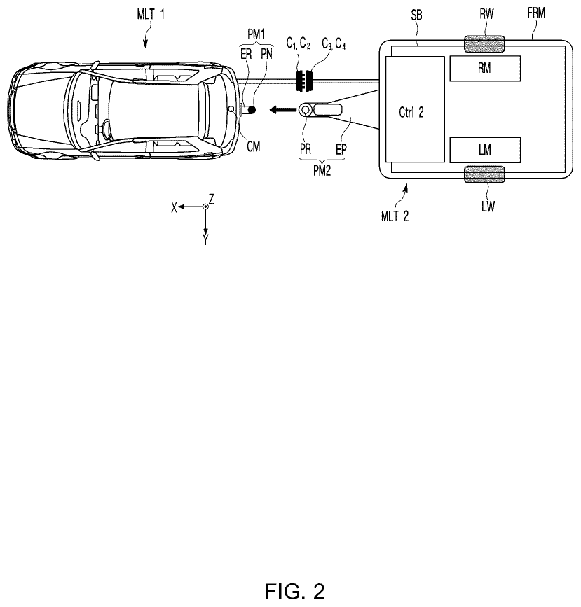

FIG. 1 is a conceptual view illustrating a power system of a first mobility MLT 1 (e.g., an electric vehicle) according to an example embodiment of the present disclosure, and FIG. 2 is a view illustrating a state in which a second mobility MLT 2 is connected to the first mobility MLT 1.

A structure of each of the first mobility MLT1 and the second mobility MLT 2 according to an example embodiment of the present disclosure will be described with reference to FIGS. 1 and 2.

As illustrated in FIG. 1, the first mobility MLT1, which may be an electric vehicle, according to an example embodiment of the present disclosure includes a first driving motor M, an inverter IN, a first battery MB, an on-board charger OBC, a first DC/DC converter L-DC, a low-voltage battery LB, an air-conditioner Air-cond and an audio video navigation AVN, which operate with a low-voltage, a second DC/DC converter L/H-DC, a switch SW, and a controller (hereinafter, referred to as a first controller).

The first driving motor M provides a driving force to wheels of the vehicle. For example, the first driving motor M may be an alternating current motor.

The inverter IN converts direct current power supplied to the first driving motor M into alternating current.

The first battery MB may be (e.g., fixedly) installed in a body of the first mobility MLT 1, such as under a cabin floor.

The first battery MB may have a main function of supplying electric power to the first driving motor M and may be charged by the on-board charger OBC.

Also, the first battery MB may be connected to the low-voltage battery LB through the first DC/DC converter L-DC to charge the low-voltage battery LB.

The first DC/DC converter L-DC may be a low-voltage DC-DC converter LDC in order to charge the low-voltage battery LB.

The low-voltage battery LB may be, for example, a 12 V or 24 V battery. The low-voltage battery LB supplies electric power to an electrical device in the vehicle, such as the air conditioner and AVN that operate at a low voltage.

A second battery SB illustrated in FIG. 1 is installed in the second mobility MLT 2 and mechanically connected through a coupling mechanism, described herein. However, the example embodiment of the present disclosure is not limited thereto. For example, the second battery SB may be mechanically connected by being detachably installed on or to the first mobility.

The second battery SB may be electrically connected as an addition to a vehicle power system including the first battery MB (e.g., in a separably wired method (or a wireless method within an allowable range)) that has no effect on an operation (e.g., power supply to electronic components of the vehicle and the driving motor) of the power system.

Also, although the second battery SB may be referred to as a replaceable battery, auxiliary battery, extended battery, second or secondary battery, this is for differentiating the second battery SB from the first battery MB. Features of the second battery SB, such as a function, characteristics, a mechanical/electrical/chemical structure according to a relationship with other objects (e.g., including the first battery MB and a host vehicle), a battery type (e.g., including the kinds of packaging method, positive electrode material/negative electrode material/separation membrane material), and a charging method, are not limited by a name of the second high-voltage battery SB.

The second battery SB may be connected to a first controller Ctrl 1 of the first mobility MLT1 or a battery management system (BMS) of the first battery MB, described herein, in a wired or wireless manner. Through this, sensing information (e.g. voltage, current, temperature, etc.) related to a SoC state and a physical/electrical/chemical state of the second battery SB is transmitted to the first controller Ctrl 1. However, the example embodiment of the present disclosure is not limited thereto. For example, the above-described information related to the second battery SB may be transmitted to the first controller Ctrl 1 through a second controller Ctrl 2 of the second mobility MLT 2, described herein.

In this example embodiment, a high-voltage battery applied to the first battery MB and the second battery SB may include a plurality of battery cells (not shown) that output a voltage of (e.g., 2.7 V to 4.2 V), and the number of the plurality of battery cells to be connected in series or parallel may be set, so that the plurality of battery cells form a (e.g., one) module. The high-voltage battery may be packaged such that one or more battery modules are connected in series or parallel as a (e.g., one) battery to output (e.g., about 400 V, about 800 V, or several kV).

Each of the first battery MB and the second battery SB may include a battery management system (BMS).

The BMS may include a battery management unit (BMU), a cell monitoring unit (CMU), and a battery junction box (BJB).

The BMS performs a cell balancing function of maintaining a voltage of each cell constant to secure a performance of an entire battery pack, a state of charge (SoC) function of calculating a capacity of an entire battery system, battery cooling, charging, and discharging control.

The BMU receives information on (e.g., all) cells from the CMU and performs the functions of the BMS based on the received information.

The BMU may include (e.g., two) micro control units (MCU), and each MCU may have a (e.g., one) CAN communication port. The BMU may further include a CAN interface to communicate with a vehicle controller that is a device at an upper hierarchy level of the BMS, and a CAN interface to collect information from the CMU that is a device at a lower hierarchy level of the BMS.

The CMU may be attached (e.g., directly) to the battery cell to sense a voltage, a current, and a temperature. The CMU may serve to perform sensing (e.g., only) instead of performing a calculation related to a BMS algorithm. A (e.g., one) CMU may be formed by connecting a plurality of battery cells and transmit information of each cell to the BMU through the CAN interface.

BJB is a pack-level sensing mechanism of the BMS and a connection medium between the high-voltage battery and a drivetrain. For (e.g., accurately) calculating the SoC, a battery voltage and a current flowing into and out of the battery are measured and recorded. Also, the BJB may perform a safety function, such as insulation monitoring in addition to overcurrent detection.

The second battery SB may be a high-voltage battery having a voltage less than that of the first battery MB, and in this case, the second DC/DC converter L/H-DC may be a step-up DC/DC converter. Alternatively, the second battery SB may be a high-voltage battery having a voltage greater than that of the first battery MB, and in this case, the second DC/DC converter L/H-DC may be a step-down DC/DC converter. Also, in this alternative example embodiment, the second DC/DC converter L/H-DC may be a bidirectional converter, and thus, the first battery MB and the second battery SB may charge and discharge each other.

In this example embodiment, although the second DC/DC converter L/H-DC is included as a built-in component of the first mobility MLT1 in the power system, the example embodiment of the present disclosure is not limited thereto. For example, unlike this example embodiment, the second DC/DC converter L/H-DC may be provided as a separate component and additionally and detachably connect to the power system. Also, the second DC/DC converter L/H-DC may be built-in or detachably included in the second mobility MLT 2.

Also, unlike the present embodiment, the second DC/DC converter L/H-DC may not be included in other embodiments. In this case, charging and discharging between the first battery MB and the second battery SB may not occur.

In this example embodiment, the power system of the first mobility MLT1 may include first and second connectors C1 and C2, and the second battery SB may include third and fourth connectors C3 and C4 for a separable electrical connection to the power system of the second battery SB.

For example, each of the first and second connectors C1 and C2 may be an integrated connector, and each of the third and fourth connectors C3 and C4 may be also an integrated connector.

The first connector C1 may be connected to the second DC/DC converter L/H-DC, and the second connector C2 may be connected to the switch SW.

Although not shown, a signal transmission connector may be added to transmit sensing and state information of the second battery SB to the controller.

The switch SW is (e.g., fixedly) electrically connected to the inverter IN and switched between the first battery MB and the second connector C2 to electrically connect the inverter IN and the first battery MB and/or the inverter IN and the second battery SB.

In this example embodiment, although the first controller Ctrl 1 may be a vehicle controller at an uppermost hierarchy level, which controls (e.g., all) electric devices of the first mobility MLT1, the example embodiment of the present disclosure is not limited thereto. For example, the first controller Ctrl 1 in FIG. 1 may be a power controller at a lower hierarchy level of the vehicle controller.

Also, in this example embodiment, as described above, the first controller Ctrl 1 may include a computer-readable recording medium that stores an operation system, a logic command, and input/output information and at least one processor that reads the above-described stored system, command, and information to perform a decision or calculation required for function control.

The second battery SB in FIG. 1 may be installed in the second mobility MLT 2 as illustrated in FIG. 2.

The second mobility MLT 2 includes a frame FRM, a second left wheel LW disposed at a left side of the frame FRM, a second right wheel RW disposed at a right side of the frame FRM, a second left driving motor LM providing driving force to the second left wheel LW, a second right driving motor RM providing driving force to the second right wheel RW, and a second controller Ctrl 2.

Although the second battery SB may be (e.g., fixedly) installed on the second mobility MLT 2, the example embodiment of the present disclosure is not limited thereto. That is, the second battery SB may be detachably installed on the second mobility MLT 2. For example, the second battery SB in a completely discharged SoC state, which is mounted to the frame FRM, may be removed and replaced with a new second battery SB in a fully charged SoC state.

When the second battery SB is (e.g., fixedly) installed on the second mobility MLT 2, the second mobility MLT 2 may include a charging connector for charging the second battery SB.

The frame FRM forms an appearance of the second mobility MLT 2 and may serve to accommodate other components.

The frame FRM may include a second pivot mechanism PM2 that is a second connection mechanism, and the second pivot mechanism PM2 may be separably pivot-connected to a first pivot mechanism PM1 that is a first connection mechanism coupled (e.g., fixed) to a body of the first mobility MLT1.

For example, the first pivot mechanism PM1 includes an extension rod ER extending rearward from the body of the first mobility MLT1 and a pivot pin PN protruding upward from an end of the extension rod ER.

Also, the second pivot mechanism PM2 includes an extension part EP having a triangular shape protruding forward from the frame FRM of the second mobility MLT 2 and a pivot ring PR disposed at an end of the extension part EP and to which the pivot pin PN is rotatably inserted.

The pivot pin PN may perform a restricted linear movement in a state of being inserted to the pivot ring PR and may (e.g., only) perform a rotation in a Z-axis direction of FIG. 2. Thus, in the pivot-connected state, the second mobility MLT2 may be restricted in linear movement using a pivot connection point as a center with respect to the first mobility MLT1 and may (e.g., only) rotate about a Z axis.

When the second mobility MLT2 travels in a forward direction (e.g., an X-axis direction), each of the first mobility MLT1 and the second mobility MLT2 may maintain straightness thereof without separate steering control.

Although the pivot mechanism is included as the first and second connection mechanisms in this example embodiment, the example embodiment of the present disclosure is not limited thereto. For example, the first and second connection mechanisms may be mechanisms that realize non-rotational connection about the Z-axis.

The second left driving motor LM has a rotation shaft that is connected to the second left wheel LW, and through this, the second left driving motor LM provides driving force to the second left wheel LW.

Also, the second right driving motor RM has a rotation shaft that is connected to the second right wheel RW, and through this, the second right driving motor RM provides driving force to the second right wheel RW.

Since the second left wheel LW and the second right wheel RW are connected to the second left driving motor LM and the second right driving motor RM, respectively, the second left wheel LW and the second right wheel RW may be driven independently from each other.

Since each of the second left driving motor LM and the second right driving motor RM may be driven in forward and backward directions, when driven in the forward direction, the second mobility MLT 2 travels forward, and when driven in the backward direction, the second mobility MLT 2 travels backward.

For example, although each of the second left driving motor LM and the second right driving motor RM may be realized as an in-wheel driving system in which each driving motor is installed in each wheel, the example embodiment of the present disclosure is not limited thereto.

Also, in comparison (e.g., unlike this example embodiment), the second mobility MLT 2 may be driven in such a manner that power of one common motor is distributed to the second left wheel LW and the second right wheel RW instead of independent driving of the left and right wheels. To this end, a differential gear may be included between the common second driving motor and the second left and right wheels LW and RW. That is, the power of the common second driving motor may be distributed by the differential gear and transmitted to the second left wheel LW and the second right wheel RW. In this case, a torque vectoring unit may be added for torque distribution between the second left wheel LW and the second right wheel RW.

In FIG. 2, the second controller Ctrl 2 controls the second left driving motor LM and the second right driving motor RM to perform forward and reverse driving of the second mobility MLT 2. Also, when steering of the second mobility MLT 2 is desired (e.g., required), the second controller Ctrl 2 may change a driving direction of the second mobility MLT2 through controlling a torque or the number of rotations of each of the second left driving motor LM and the second right driving motor RM. That is, the steering of the second mobility MLT 2 may be performed without a separate steering device through independent control of the driving of the second left driving motor LM and the second right driving motor RM.

Also, as described above, the connectors and the wired or wireless communication units for transmitting information between the first mobility MLT1 and the second mobility MLT2 in FIG. 1 are included.

In this example embodiment, each of the first controller Ctrl 1 and/or the second controller Ctrl 2 may include a memory and a processor. The memory stores computer commands (e.g., programs) for performing functions of the corresponding controller, and the processor performs the above-described functions by reading and executing the commands from the memory.

For example, the memory includes at least one of a hard disk drive (HDD), a solid-state drive (SDD), a silicon disk drive (SDD), ROM, RAM, CD-ROM, a magnetic tape, a floppy disk, and an optical data storage device.

Also, for example, the processor includes at least one of a computer, a microprocessor, a central processing unit (CPU), an ASIC, an electric circuit, and a logic circuit.

As the first connector C1 and the second connector C2 of the first mobility MLT 1 and the third connector C3 and the fourth connector C4 of the second mobility MLT 2 are connected, and the connector for signal transmission is connected, such that the first mobility MLT 1 and the second mobility MLT 2 (e.g., the first controller Ctrl 1 and the second controller Ctrl 2) may communicate with each other.

When the first mobility MLT 1 initiates travel forward in a state in which the first mobility MLT 1 and the second mobility MLT 2 are mechanically and electrically connected, according to a driving speed signal transmitted from the first connector C1, the second controller Ctrl 2 controls the second left driving motor LM and the second right driving motor RM to perform a forward straight driving of the second mobility MLT 2.

Here, a speed, a gear position, a steering angle, accelerator pedal sensor (APS) information, and/or brake pedal sensor (BPS) information of the first mobility MLT 1 may be transmitted to the second mobility MLT 2.

The second controller Ctrl 2 of the second mobility MLT 2 may determine whether the first mobility MLT 1 is in a forward driving state or a backward driving state by using, for example, the speed, the gear position, the APS information, and/or the BPS information of the first mobility MLT 1. However, the example embodiment of the present disclosure is not limited thereto. For example, the second controller Ctrl 2 may (e.g., directly) receive information on whether the first mobility MLT 1 is in the forward driving state or the backward driving state from the first controller Ctrl 1.

When the first mobility MLT1 travels forward, the second controller Ctrl 2 drives the second left driving motor LM and the second right driving motor RM in the forward direction to perform the forward driving of the second mobility MLT 2. When the first mobility MLT1 travels backward, the second controller Ctrl 2 drives the second left driving motor LM and the second right driving motor RM in the backward direction to perform the backward driving of the second mobility MLT 2.

Also, the second controller Ctrl 2 may determine a steering state through steering angle information of the first mobility MLT 1 and perform steering of the second mobility MLT 2 based on the determined steering state.

The second mobility MLT 2 may not include a separate steering device such as a steering wheel and a steering rack and may perform the steering through torque control of the second left driving motor LM and the second right driving motor RM.

That is, the second controller Ctrl 2 may calculate driving torque for driving and steering torque for steering for each of the second left driving motor LM and the second right driving motor RM and use the calculated torque for control.

For example, a lookup table or calculation program may include steering torque values of the second left driving motor LM and the second right driving motor RM according to the steering angle of the first mobility MLT 1 to perform steering of the second mobility MLT 2.

During the forward straight driving, the second mobility MLT 2 may be controlled to travel at a speed equal to or less than that of the first mobility MLT 1. Through this, the pivot connection between the first mobility MLT 1 and the second mobility MLT 2 may be maintained within a predetermined pivot angle range. For example, when a speed of the second mobility MLT 2 is controlled to be equal to or less than that of the first mobility MLT 1 during the forward straight driving, a pivot angle of the second mobility MLT2 with respect to the first mobility MLT 1 at a pivot connection point may maintain 0° (which represents an angle at which the first mobility MLT 1 and the second mobility MLT 2 are on a straight line).

During the forward straight driving, the second mobility MLT 2 may be controlled to follow the first mobility MLT 1, and through this, a plurality of mobilities may be (e.g., smoothly) connected to travel.

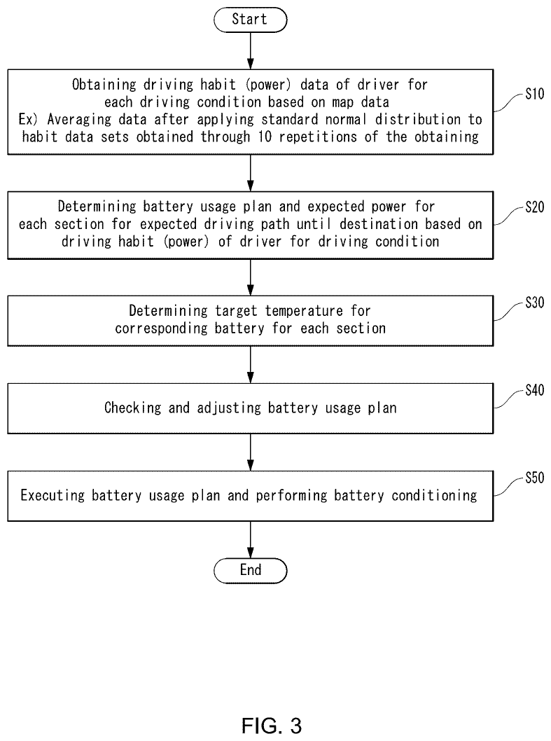

FIG. 3 is a flowchart illustrating a battery control process according to an example embodiment of the present disclosure, which will be described in detail below.

Although a control process of the battery is performed under control of the first controller Ctrl 1 in this example embodiment, the example embodiment of the present disclosure is not limited thereto.

The first controller Ctrl 1 includes a memory and a processor as described herein. The memory stores a computer program for a battery controls process according to the example embodiment and, as useful (e.g., necessary), may store various data (e.g., required) for the control process. The processor executes the program stored in the memory, and through this, the first controller Ctrl 1 may perform the battery control process.

Referring to FIG. 3, in step S10, the first controller Ctrl 1 collects (e.g., acquires) a driver's driving habit for each driving condition based on map data.

The map data may be, for example, the map data for navigation of the AVN system, but is not necessarily limited to this.

The driving condition may, for example, be based on a road type indicated by the map data.

For example, the driving condition may be distinguished, based on the map data, into a plurality of sections, such as an urban road section, a mountainous up-hill section, a mountainous down-hill section, a highway section, a national road section, and a regenerative braking section.

The urban road section may include a road section provided as the urban road in the map data, the mountainous section may include a road section provided as the mountainous road in the map data, and the highway section and the national road section may include a road section provided as a highway and a road section provided as a national road, respectively, in the map data.

Also, regenerative braking may be performed based on a predetermined regenerative braking condition during driving, and the corresponding section may be provided as the regenerative braking section.

For example, the regenerative braking condition may include a deceleration rate, a driving distance or time to a target speed, and a state of charge (SoC) of the battery. However, the example embodiment of the present disclosure is not limited thereto.

The data on the driver's driving habit for each driving condition may be acquired, for example, through learning.

To this end, the power supplied to the driving motor M based on an (e.g., required) output of the driver during the driving of the vehicle over a preset driving distance for each driving condition (e.g., discharging power data of the battery MB or SB) is obtained in real time to determine the average discharging power during the driving distance and obtain average discharging power data by repeating this process a set number of times.

Also, an average value based on probability weighted value may be determined by applying a standard normal distribution to the obtained average discharging power data to determine average discharging power for the corresponding driving condition.

Here, for example, the required output of the driver may be determined based on a signal of an accelerator position sensor (APS).

Also, the regenerative braking power based on a deceleration demand of the driver during the predetermined driving distance for each driving condition (e.g., regenerative braking charging power data in the battery) may be collected in real-time to determine the average charging power during the driving distance and repeating this process a set number of times, thereby obtaining the average charging power data.

Also, in the same manner, an average value based on the probability weighted value may be determined by applying the standard normal distribution to the obtained average charging power data, and the determined average value may be determined as the average charging power for the corresponding driving condition.

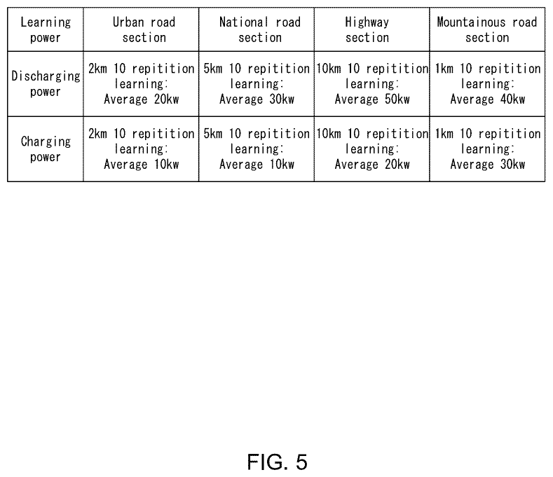

FIG. 5 is a table showing an example of obtaining average power through learning for each driving condition, described herein.

First, in an example embodiment, average discharging power by applying the standard normal distribution to discharging power obtained while driving 2 km on the urban road section for 10 repetitions is 20 kw.

Also, in an example embodiment, the average charging power by applying the standard normal distribution to discharging power obtained while driving 2 km on the urban road section for 10 repetitions is 10 kw.

In an example embodiment, average discharging power by applying the standard normal distribution to discharging power obtained while driving 5 km on the national road section for 10 repetitions is 30 kw, and average charging power by applying the standard normal distribution to charging power obtained while driving 5 km on the national road section for 10 repetitions is 10 kw.

In an example embodiment, average discharging power by applying the standard normal distribution to discharging power obtained while driving 5 km on the highway section for 10 repetitions is 50 kw, and the average discharging power by applying the standard normal distribution to charging power obtained while driving 5 km on the highway section for 10 repetitions is 20 kw.

Also, in an example embodiment, average discharging power by applying the standard normal distribution to discharging power obtained while driving 1 km on the mountainous road section for 10 repetitions is 40 kw, and the average discharging power by applying the standard normal distribution to charging power obtained while driving 1 km on the mountainous road section for 10 repetitions is 30 kw.

The driving habit data for each driving condition may be (e.g., continuously) updated by accumulating data for each condition.

Referring back to FIG. 3, in step S20, the first controller Ctrl 1 may determine at least one section based on the driving habit data for each driving condition for the expected driving path and determine expected power and a battery usage plan for each section.

For example, the expected driving path may be determined based on a path from a current location to a destination when the destination is input into the AVN.

For example, at least one section may be determined as the expected driving path based on driving conditions based on the urban road section, the mountainous road section, the highway section, the national road section, and the regenerative braking section.

The first controller Ctrl 1 may determine expected power (e.g., charging or discharging power) for each section based on the driving habit data for each driving condition.

Also, the first controller Ctrl 1 may determine the battery to be used, such as the first battery MB and/or the second battery SB, for each section.

The battery to be used in each section may be determined based on the expected power for the corresponding section and the output power of a maximum efficiency of a lower voltage battery among the first battery MB and the second battery SB.

Hereinafter, an example in which the first battery MB is the lower voltage battery than the second battery SB will be described. However, this is an example and the example embodiment of the present disclosure is not limited thereto. Hereinafter, for convenience and clarity in the description, the first battery MB will be referred to as a ‘low-voltage battery,’ and the second battery SB will be referred to as a ‘high-voltage battery’. Also, the terms ‘low-voltage battery’ and ‘high-voltage battery’ are used for convenience based on a relative difference between two batteries. However, the example embodiment of the present disclosure is not limited thereto.

In order to determine which battery will be used in each section, the expected power for each section may be compared with maximum efficiency output power (e.g., set power) of the first battery MB.

Also, based on the comparison results, the usage plan may be determined so that the first battery MB is used in a section in which the expected power is equal to or less than the maximum efficiency output power, and the second battery SB is used in other sections.

Thereafter, in step S30, the first controller Ctrl 1 may determine a target temperature for the corresponding battery for each section for battery conditioning.

To this end, optimized temperature data for each battery state (e.g., SoH, SoC, voltage) may be stored (e.g., in advance) in memory.

Also, the data may be secured through an experiment.

Also, the optimized temperature data may be secured according to characteristics of each battery. For example, the optimized temperature data may be obtained based on characteristics (or specifications), such as a C-rate, a nominal voltage, an efficiency, maximum current, a system voltage, and continuous output (power) of a battery.

The first battery MB and the second battery SB may have different characteristics. Thus, a target temperature for the section in which the first battery MB is used may be determined based on the temperature data or closest data of the characteristics of the first battery MB. A target temperature for the section in which the second battery SB is used may be determined in the same manner.

Thereafter, in step S40, the first controller Ctrl 1 checks the usage plan for the dual batteries and may perform an adjustment thereof (e.g., when necessary).

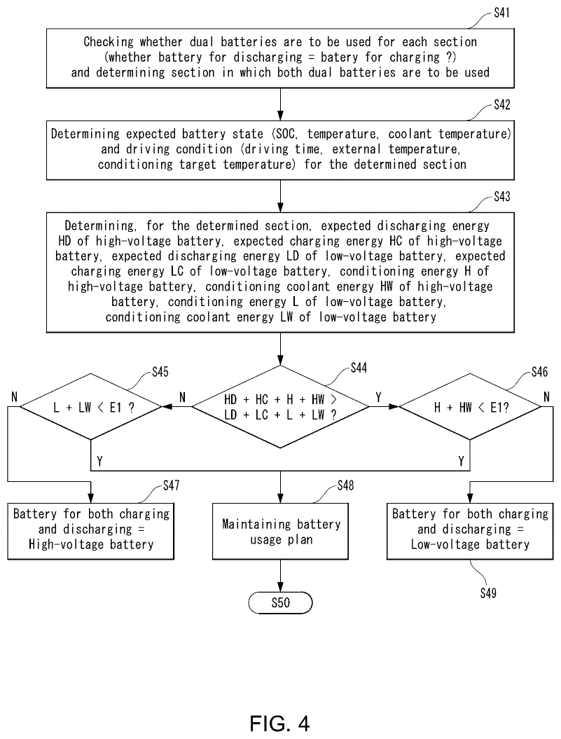

Hereinafter, an example of step S40 is described in detail with reference to FIG. 4.

First, in step S41, the first controller Ctrl 1 checks sections in which the battery used in the previous section is changed in the next section.

Also, the first controller Ctrl 1 may determine the battery to be used among the first battery MB and the second battery SB for each section.

Here, use of both dual batteries includes using the first battery MB for one of charging or discharging and using the second battery SB for the other of charging or discharging.

For example, when it is determined that the first controller Ctrl 1 supplies power to the first driving motor M using the first battery MB in a section, and regenerative energy collected by the first driving motor M charges the second battery SB, the corresponding section may be a section in which both dual batteries (e.g., the first battery MB and the second battery SB) are used.

The first controller Ctrl 1 may adjust the corresponding usage plan through steps S42 to S49 when the section in which both dual batteries are used is checked in the step S41.

To this end, in step S42, the first controller Ctrl 1 determines the anticipated battery state and driving environment for the subsequent section for both the first battery MB and the second battery SB. Here, the expected battery states may include SOC, temperature, and coolant temperature, while the driving environment may include driving time, ambient temperature, and conditioning target temperature.

Thereafter, in step S43, the first controller Ctrl 1 may determine the first expected consumption energy related to the first battery MB and the second expected consumption energy related to the second battery SB for the corresponding section.

The expected consumption energy may include expected discharging energy, expected charging energy, expected conditioning energy, and coolant energy.

In the dual batteries, expected discharging energy HD, expected charging energy HC, expected conditioning energy H, and coolant energy HW for the high-voltage battery may be determined by the following mathematical equations in set 1.

$$HD = Dt \times {I\_hd}^{2} \times R\_h \qquad Mathematical Equations , Set 1$$

$$HC = Dt \times {I\_hc}^{2} \times R\_h$$

$$H = M\_h \times ρ\_h \times \vert T\_ht - T\_hcw \vert \times Dt$$

$$HW = M\_hcw \times ρ\_hcw \times \vert T\_hcw - T\_a \vert \times Dt$$

For the above mathematical equations in set 1, Dt represents a driving time for the corresponding section, I_hd represents expected discharging current of the high-voltage battery, R_h represents system resistance of the high-voltage battery, I_hc represents expected charging current of the high-voltage battery, M_h represents a mass of the high-voltage battery, ρ_h represents specific heat of the high-voltage battery, T_ht represents a conditioning target temperature for the high-voltage battery, T_hcw represents a cooling water temperature for conditioning the high-voltage battery, M_hcw represents a mass of coolant used for conditioning the high-voltage battery, ρ_hcw represents specific heat of the coolant for high-voltage battery conditioning, and T_a represents an external temperature.

Also, in the dual batteries, expected discharging energy LD, expected charging energy LC, expected conditioning energy L, and coolant energy LW for the low-voltage battery may be determined by the following mathematical equations in set 2.

$$LD = Dt \times {I\_ld}^{2} \times R\_l \qquad Mathematical Equations , Set 2$$

$$LC = Dt \times {I\_lc}^{2} \times R\_l$$

$$L = M\_ 1 \times ρ\_ 1 \times \vert T\_lt - T\_lcw \vert \times Dt$$

$$LW = M\_lcw \times ρ\_lcw \times \vert T\_lcw - T\_a \vert \times Dt$$

For the above mathematical equations in set 2, I_ld represents expected discharging current of the low-voltage battery, R_l represents system resistance of the low-voltage battery, I_lc represents expected charging current of the low-voltage battery, M_l represents a mass of the low-voltage battery, ρ_1 represents specific heat of the low-voltage battery, T_lt represents a conditioning target temperature for the low-voltage battery, T_lcw represents a coolant temperature for conditioning the low-voltage battery, M_lcw represents a mass of the coolant used for conditioning the low-voltage battery, and ρ_lcw represents specific heat of the coolant used for conditioning the low-voltage battery.

The first controller Ctrl 1 compares the first expected consumption energy with the second expected consumption energy in step S44.

When it is determined in step S44 that the first expected consumption energy is greater than the second expected consumption energy, a sum of the expected conditioning energy L and the coolant energy LW for the first battery MB is compared to a preset energy E1 in step S45.

When the sum of the expected conditioning energy L and the coolant energy LW for the first battery MB is equal to or greater than the preset energy E1 in step S45, the high-voltage battery is determined as the battery to be used for the corresponding section in step S47. Otherwise, the existing usage plan, e.g., the usage plan determined in step S20 for the corresponding section, is maintained in step S48.

Also, when it is determined in step S44 that the second expected consumption energy is greater than the first expected consumption energy, a sum of the expected conditioning energy H and the coolant energy HW for the second battery SB is compared with the preset energy E1 in step S46.

When the sum of the expected conditioning energy H and the coolant energy HW for the second battery SB is equal to or greater than the preset energy E1 in step S46, the low-voltage battery is determined as the battery to be used for the corresponding section in step S49. Otherwise, the existing usage plan, e.g., the usage plan determined in step S20 for the corresponding section, is maintained in step S48.

Also, although not shown in FIG. 4, when it is determined in step S44 that the second expected consumption energy is equal to the first expected consumption energy, the process may proceed to step S45 or step S46.

Referring to FIG. 3 again, in step S50, the first controller Ctrl 1 discharges or charges the first battery MB and the second battery SB based on the battery usage plan.

Also, the first controller Ctrl 1 performs conditioning control of the first battery MB and the second battery SB based on the usage plan and the target temperature for each section.

The conditioning control may include, for example, heating the corresponding battery to the target temperature using an electric heater.

Also, the conditioning control may be executed by using power of the rest battery in the section before the corresponding battery is used.

For example, the conditioning control for the second battery SB to be used in the next section may be performed by using the power of the first battery MB in a section in which the first battery MB is used.

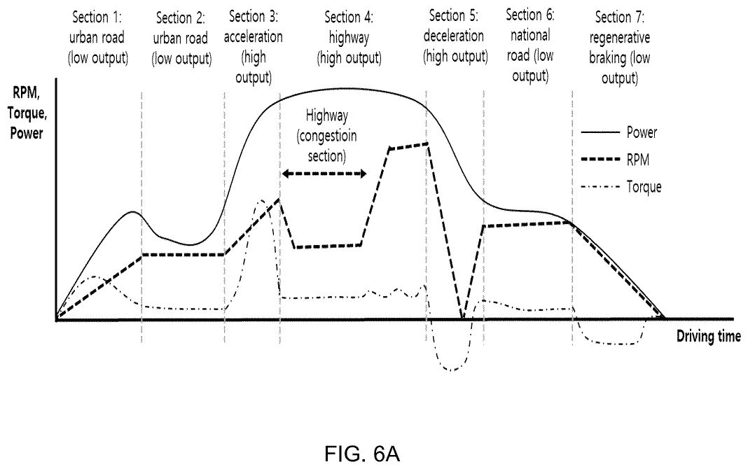

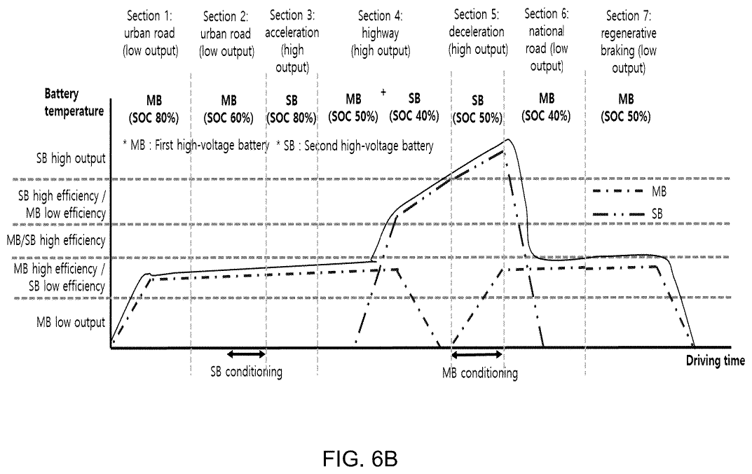

FIGS. 6A and 6B are graphs illustrating a driving simulation according to an example embodiment of the present disclosure, which will be described below.

First, FIG. 6A illustrates the number of rotation RPM and torque of the driving motor and the discharge or charging power, for each section when sections 1 to 6 are distinguished for the expected driving path.

Sections 1 to 6 may be distinguished based on reference that distinguish driving conditions based on map data as described herein.

In FIGS. 6A and 6B, sections 1 and 2 represent urban road sections with low output power, section 3 represents a high-output acceleration section (e.g., an uphill mountainous road), section 4 represents a high-output highway section, section 5 represents a regenerative braking section characterized by high-output regenerative power during deceleration (e.g., a downhill mountainous road), section 6 represents a low-output national road section, and section 7 represents a regenerative braking section with low-output regenerative power.

As shown, it is determined that the battery used in sections 1, 2, 6, and 7 is the first battery MB that is the lower voltage battery among the two batteries, and the battery used in sections 3 and 5 is the second battery SB.

Although the usage plan is determined to use the first battery MB in section 4, the second battery SB is used together with the first battery MB because the first battery MB alone may not satisfy the requested power of the driver.

As the battery is used based on the usage plan, the SoC of the first battery MB decreases from 80% in section 1 to 60% in section 2, 50% in section 4, and 40% in section 6 and is recovered to 50% in section 7 by the regenerative braking power.

On the other hand, the SoC of the second battery SB is 80% in section 3, decreases to 40% in section 4, and then recovers to 50% in section 5 by charging.

Also, in section 3, according to the plan to use the second battery SB, pre-conditioning of the second battery SB is performed by using the power of the first battery MB in section 2.

Likewise, according to the plan to use the first battery MB in section 6, pre-conditioning of the first battery MB is performed by using the power of the second battery SB in section 5.

FIG. 6B illustrates the battery temperature during driving from section 1 to section 7. When the corresponding temperature is obtained through the conditioning control, since the battery usage plan is different for each driving condition according to the example embodiment, energy consumed for battery conditioning approximately corresponds to an area expressed by solid line.

In contrast, in case of a comparative example that does not have a battery usage plan instead of the example embodiment, the first battery MB and the second battery SB may perform the conditioning control in the same manner. Thus, energy consumed for the conditioning control may approximately correspond to two times of the area expressed by the solid line.

Thus, according to the example embodiment, the battery conditioning may be (e.g., efficiently) performed, and thus, the consumption energy may be reduced.

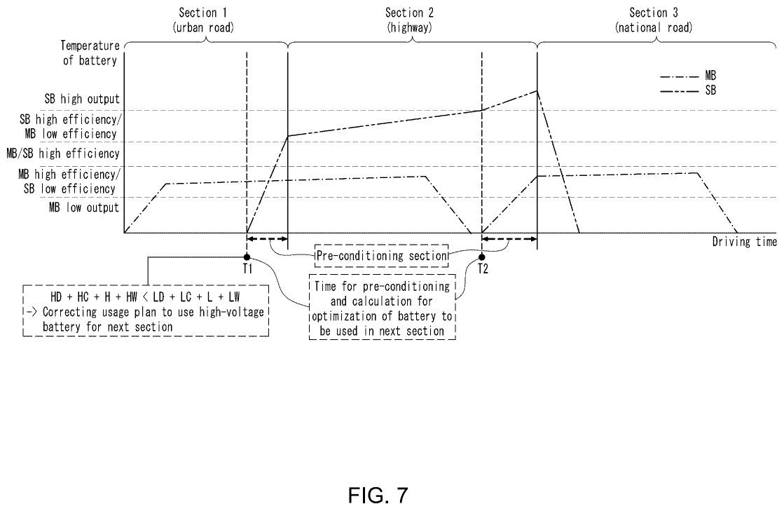

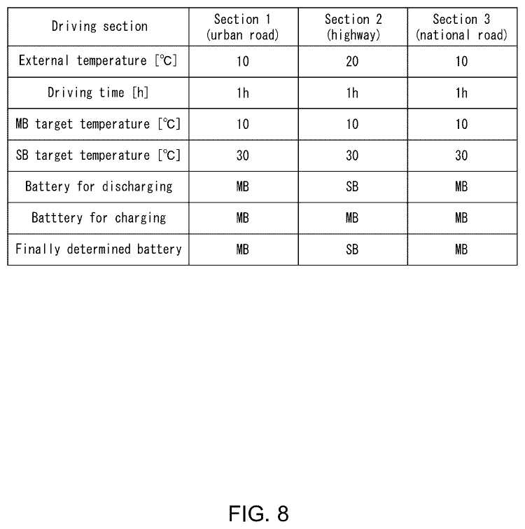

FIGS. 7 and 8 are views illustrating another assumed driving simulation according to an example embodiment of the present disclosure, which will be described hereinbelow.

In FIG. 7, section 1 represents an urban road driving section, section 2 represents a highway driving section, and section 3 represents a national road driving section for a total expected driving distance.

As shown in FIG. 7, the second battery SB is used in section 1, both the first battery MB and the second battery SB are used in a beginning of section 2, and the second battery SB is used in section 3 based on the battery usage plan.

As shown in FIG. 8, both the dual batteries are used in section 2 based on the usage plan in step S20 for the expected driving distance of FIG. 7. Here, the battery supplying power to the first drive motor M, such as the discharging battery, is determined to be the second battery SB that is the high-voltage battery, and the battery receiving regenerative energy from regenerative braking by the first driving motor M, such as the charging battery, is determined to be the first battery MB.

The first controller Ctrl 1 compares the first expected consumption energy with the second expected consumption energy before entering section 2 in step S44 and determines that the first expected consumption energy is greater than the second expected consumption energy to change the usage plan for section 2.

As shown in FIG. 8, since the first expected consumption energy is greater than the second expected consumption energy in section 2, the first controller Ctrl 1 corrects the usage plan for section 2 and determines the second battery SB that is the high-voltage battery as the charging and discharging battery.

According to an example embodiment of the present disclosure, the driving distance of the electric vehicle may be extended, and the usability thereof may be improved by detachably connecting the second high-voltage battery to the power system of the electric vehicle.

Also, according to an example embodiment of the present disclosure, the efficiency and lifespan of the battery may be increased by (e.g., efficiently) operating the dual batteries based on the learned driving condition and the driving habits of the driver for each driving condition.

Also, the energy efficiency may be optimized through the individual operation of the dual batteries based on the driving habits of the driver for each driving condition.

According to an example embodiment of the present disclosure, in the usage plan for the dual batteries based on the expected driving distance, for the section in which both dual batteries are used, the usage plan may be corrected from the perspective of energy efficiency to improve the energy efficiency.

Also, the energy consumed for conditioning the dual batteries may be reduced through the individual conditioning control based on the usage plan.

Also, the high-efficiency area of the battery may be used immediately when the battery is replaced through the pre-conditioning,

Although embodiments of the present disclosure have been described above, these are illustrative examples and should not be construed as limiting the present disclosure to these embodiments.

What is claimed is:

1. A method for controlling dual batteries to supply power to a driving motor for wheel driving installed in a vehicle and control a power flow between a first battery of the dual batteries and a second battery of the dual batteries, the method comprising:
determining, by a controller, a usage plan of the first battery and the second battery for a section of an expected driving path; and
charging or discharging the first battery and the second battery based on the usage plan.

2. The method of claim 1, further comprising correcting a first usage plan for a first section of the expected driving path in which both the first battery and the second battery are used according to the determined usage plan.

3. The method of claim 2, wherein correcting the first usage plan comprises correcting the first usage plan based on an expected consumption energy of the first battery and the second battery.

4. The method of claim 3, wherein the expected consumption energy comprises at least one of a battery discharging energy, a battery charging energy, a battery conditioning energy, or a coolant energy.

5. The method of claim 4, wherein correcting the first usage plan comprises comparing a first expected consumption energy for the first battery with a second expected consumption energy for the second battery.

6. The method of claim 5, wherein correcting the first usage plan comprises
determining the second battery as a battery for the charging or discharging process in the first section when the first expected consumption energy is greater than the second expected consumption energy, or
determining the first battery as a battery for the charging or discharging process in the first section when the first expected consumption energy is less than the second expected consumption energy.

7. The method of claim 6, wherein correcting the first usage plan further comprises maintaining the first usage plan when a sum of the battery conditioning energy and the coolant energy, related to the first battery or the second battery, for the first section is less than a set energy.

8. The method of claim 2, wherein the first section comprises a section in which the first battery is used for a charging process and the second battery is used for a discharging process, or the first battery is used for a discharging process and the second battery is used for a charging process.

9. The method of claim 1, further comprising:
dividing the expected driving path into a plurality of sections based on driving conditions to determine at least one section; and
determining an expected power for the at least one section of the plurality of sections based on driving habit data,
wherein determining the usage plan comprises determining the usage plan based on an expected power.

10. The method of claim 9, further comprising performing a conditioning control for the first battery or the second battery based on the usage plan.

11. A vehicle comprising:
a plurality of wheels;
a driving motor configured to drive at least one of the plurality of wheels; and
a controller configured to control a power flow between the driving motor and a first battery or a second battery,
wherein the controller comprises a memory storing computer-readable instructions and at least one processor configured to access the memory and execute the computer-readable instructions, and
wherein the computer-readable instructions comprise
determining a usage plan of the first battery and the second battery for section of an expected driving path, and
charging or discharging the first battery and the second battery based on the usage plan.

12. The vehicle of claim 11, wherein the computer-readable instructions further comprise correcting a first usage plan for a first section in which the first battery and the second battery are used according to the determined usage plan.

13. The vehicle of claim 12, wherein the computer-readable instructions further comprise correcting the first usage plan based on an expected consumption energy from use of the first battery and the second battery.

14. The vehicle of claim 13, wherein the expected consumption energy comprises at least one of a battery discharging energy, a battery charging energy, a battery conditioning energy, or a coolant energy.

15. The vehicle of claim 14, wherein the computer-readable instructions further comprise comparing a first expected consumption energy for the first battery with a second expected consumption energy for the second battery.

16. The vehicle of claim 15, wherein the computer-readable instructions further comprise
determining the second battery as a battery for the charging or discharging process in the first section when the first expected consumption energy is greater than the second expected consumption energy, or
determining the first battery as a battery for the charging or discharging process in the first section when the first expected consumption energy is less than the second expected consumption energy.

17. The vehicle of claim 16, wherein the computer-readable instructions further comprise maintaining the first usage plan when a sum of the battery conditioning energy and the coolant energy related to the first battery or the second battery for the first section is less than a set energy.

18. The vehicle of claim 12, wherein the first section comprises a section in which the first battery is used for a charging process and the second battery is used for a discharging process, or the first battery is used for a discharging process and the second battery is used for a charging process.

19. The vehicle of claim 11, wherein the computer-readable instructions further comprise dividing the expected driving path into a plurality of sections based on driving conditions to determine at least one section and determine an expected power for the at least one section of the plurality of sections based on driving habit data,
wherein determining the usage plan comprises determining the usage plan based on the expected power.

20. The vehicle of claim 19, wherein the computer-readable instructions further comprise performing a conditioning control for the first battery or the second battery based on the usage plan.
